(19) United States
(12) Patent Application Publication
(10) Pub. No.: US 2026/0323644 A1
(43) Pub. Date: Oct. 15, 2026

(54) UPLINK 8-PORT CODEBOOK GENERATION METHOD AND APPARATUS, DEVICE AND STORAGE MEDIUM

(71) Applicant: Beijing Xiaomi Mobile Software Co., Ltd., Beijing (CN)

(72) Inventors: Zhenyu ZHANG, Beijing (CN); Xueyuan GAO, Beijing (CN)

(73) Assignee: Beijing Xiaomi Mobile Software Co., Ltd., Beijing (CN)

(21) Appl. No.: 19/103,096

(22) PCT Filed: Aug. 12, 2022
(86) PCT No.: PCT/CN2022/112314

§ 371 Date: Feb. 11, 2025

(51) Int. Cl. H04W 72/21; H04B 7/06

(52) U.S. Cl. CPC H04W 72/21; H04B 7/0639

(57) ABSTRACT

Disclosed in embodiments of the present disclosure are uplink 8-port codebook generation methods, apparatuses, devices and storage media, which can be applied to the field of communication technology, where the method performed by a network-side device includes: acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set.

### CROSS-REFERENCE TO RELATED APPLICATION

The present application is a U.S. National Stage of International Application No. PCT/CN2022/112314, filed on Aug. 12, 2022, the contents of which are incorporated herein by reference in their entirety.

### TECHNICAL FIELD

The present disclosure relates to the field of communication technology, and in particular, to uplink 8-port codebook generation methods, apparatuses, devices and storage media.

### BACKGROUND

In the New Radio (NR) system of the 5th Generation (5G) wireless communication system, considering the uplink transmission with Multiple Input Multiple Output (MIMO), the maximum number of antenna ports supported by each terminal device is proposed to be expanded from 4 to 8. As the number of antenna ports and layers increases, it will lead to a significant increase in the number of codewords in the codebook set, resulting in higher overhead for Transmit Precoding Matrix Indicator (TPMI). Therefore, designing an appropriate codeword generation scheme for uplink 8-port transmission is crucial.

### SUMMARY

In a first aspect, an embodiment of the present disclosure provides a method for generating an uplink 8-port codebook, which is performed by a network-side device and including: acquiring a first codeword set; generating a second codeword set according to the first codeword set; generating an uplink 8-port fully coherent transmission codeword set according to the second codeword set; and generating an uplink 8-port codebook of a terminal device according to the uplink 8-port fully coherent transmission codeword set.

In a second aspect, an embodiment of the present disclosure provides another method for generating an uplink 8-port codebook, which is performed by a terminal device and including: receiving a transmit precoding matrix indicator (TPMI) sent by a network-side device, and determining an uplink 8-port codebook according to the TPMI.

In a third aspect, an embodiment of the present disclosure provides a communication apparatus, which includes a processor, and when the processor calls a computer program in a memory, is configured to acquire a first codeword set; generate a second codeword set according to the first codeword set; generate an uplink 8-port fully coherent transmission codeword set according to the second codeword set; and generate an uplink 8-port codebook of a terminal device according to the uplink 8-port fully coherent transmission codeword set.

### BRIEF DESCRIPTION OF DRAWINGS

In order to more clearly illustrate the technical solutions in the embodiments or background art of the present disclosure, the accompanying drawings to be used in the embodiments or background art of the present disclosure will be described below.

FIG. 1 is a schematic architectural diagram of a communication system according to an embodiment of the present disclosure.

FIG. 2 is a flowchart of a method for generating an uplink 8-port codebook according to an embodiment of the present disclosure.

FIG. 3 is a flowchart of a method for generating an uplink 8-port codebook according to an embodiment of the present disclosure.

FIG. 4 is a probability distribution diagram under a CDL-C channel in an embodiment of the present disclosure.

FIG. 5 is a flowchart of a method for generating an uplink 8-port codebook according to an embodiment of the present disclosure.

FIG. 6 is a flowchart of a method for generating an uplink 8-port codebook according to an embodiment of the present disclosure.

FIG. 7 is a flowchart of a method for generating an uplink 8-port codebook according to an embodiment of the present disclosure.

FIG. 8 is a flowchart of a method for generating an uplink 8-port codebook according to an embodiment of the present disclosure.

FIG. 9 is a flowchart of a method for generating an uplink 8-port codebook according to an embodiment of the present disclosure.

FIG. 10 is a flowchart of a method for generating an uplink 8-port codebook according to an embodiment of the present disclosure.

FIG. 11 is a flowchart of a method for generating an uplink 8-port codebook according to an embodiment of the present disclosure.

FIG. 12 is a schematic structural diagram of an information transmission apparatus according to an embodiment of the present disclosure.

FIG. 13 is a schematic structural diagram of an information transmission apparatus according to an embodiment of the present disclosure.

FIG. 14 is a schematic structural diagram of another communication apparatus according to an embodiment of the present disclosure.

FIG. 15 is a schematic structural diagram of a chip according to an embodiment of the present disclosure.

### DETAILED DESCRIPTION

Embodiments of the present disclosure are further described in connection with the accompanying drawings and specific embodiments.

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the embodiments of the present disclosure. Rather, they are merely examples of apparatuses and methods consistent with some aspects of the present disclosure as detailed in the appended claims.

Terms used in embodiments of the present disclosure are only for a purpose of describing specific embodiments, and are not limiting the embodiments of the present disclosure. Singular forms of “a”, said”, and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

Depending on the context, the word “if”′ and “in response to” as used herein can be interpreted as “at” or “when” or “in response to determining”.

Hereinafter, embodiments of the present disclosure will be described in detail, examples of which are illustrated in the accompanying drawings, where the same or similar reference numerals indicate the same or similar elements throughout. Embodiments described below by referring to the accompanying drawings are exemplary and are intended to explain the present disclosure, and should not be construed as limiting the present disclosure.

In order to facilitate understanding, the terms involved in the present disclosure are first introduced.

### 1. Rank Indicator (RI)—

RI can be used to determine the number of transmission layers.

### 2. Transmit Precoding Matrix Indicator (TPMI)—

The terminal device can determine the number of layers and the precoding matrix for uplink transmission according to the TPMI and the number of transmission layers, and then perform precoding and transmit data.

3. Modulation and coding scheme (MCS)—

Generally, MCS defines the number of effective bits that can be carried by a resource element (RE). Specifically, MCS can define two parts: modulation scheme (Modulation) and code rate (CR).

In order to better understand the method for generating an uplink 8-port codebook disclosed in embodiments of the present disclosure, a communication system applicable to the embodiments of the present disclosure will be described below.

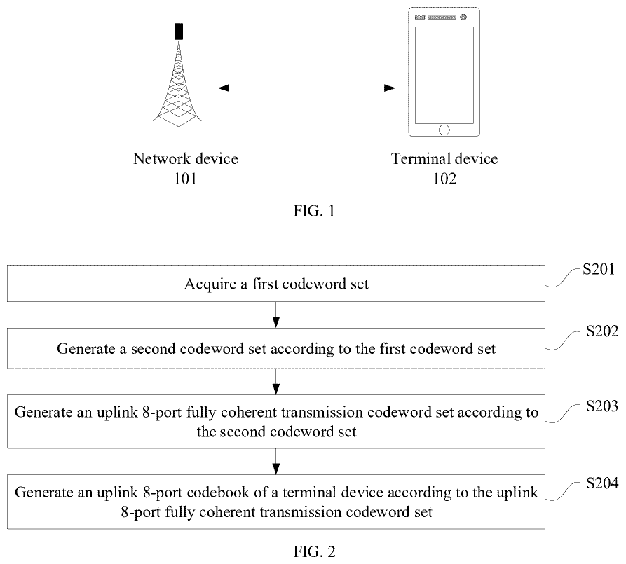

Referring to FIG. 1, FIG. 1 is a schematic architectural diagram of a communication system according to an embodiment of the present disclosure. The communication system may include, but is not limited to, a network device and a terminal device. The number and form of devices shown in FIG. 1 are only for example and do not constitute a limitation to the embodiments of the present disclosure. In practical application, it may include two or more network devices and two or more terminal devices. The communication system shown in FIG. 1 is exemplified by including a network device 101 and a terminal device 102.

It should be noted that the technical solutions of the embodiments of the present disclosure can be applied to various communication systems. For example: a long term evolution (LTE) system, a 5th generation (5G) mobile communication system, a 5G new radio (NR) system, or other future new mobile communication systems.

The network device 101 in the embodiment of the present disclosure is an entity on a network side for transmitting or receiving signals. For example, the network device 101 may be an evolved NodeB (eNB), a transmission reception point (TRP), a next generation NodeB (gNB) in an NR system, a base station in other future mobile communication systems or an access node in a wireless fidelity (WiFi) system. The embodiments of the present disclosure do not limit specific technologies and specific device forms adopted by the network device.

The network device provided by the embodiment of the present disclosure may be composed of a central unit (CU) and a distributed unit (DU), where CU may also be named as a control unit. With a structure of CU-DU, protocol layers of a network device, such as a base station, can be separated, and some functions of the protocol layers are centralized controlled by CU, while some or all functions of the remaining protocol layers are distributed in DU, which is centralized controlled by CU.

The terminal device 102 in the embodiment of the present disclosure is an entity, such as a mobile phone, on a user side for receiving or transmitting signals. The terminal device can also be named as a terminal, a user equipment (UE), a mobile station (MS), a mobile terminal (MT) and so on. The terminal device can be a car with communication function, a smart car, a mobile phone, a wearable device, a Pad, a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc.

The embodiments of the present disclosure do not limit specific technologies and specific device forms adopted by the terminal device.

It is to be understood that the communication system described in the embodiments of the present disclosure is intended to more clearly illustrate the technical solutions of the embodiments of the present disclosure and does not constitute a limitation of the technical solutions provided by the embodiments of the present disclosure, and a person of ordinary skill in the art may know that, with an evolution of a system architecture and an emergence of a new business scenario, the technical solutions provided by the embodiments of the present disclosure are equally applicable to similar technical problems.

It is to be understood that the communication system described in the embodiments of the present disclosure is intended to more clearly illustrate the technical solutions of the embodiments of the present disclosure and does not constitute a limitation of the technical solutions provided by the embodiments of the present disclosure, and a person of ordinary skill in the art may know that, with an evolution of a system architecture and an emergence of a new business scenario, the technical solutions provided by the embodiments of the present disclosure are equally applicable to similar technical problems.

Hereinafter, methods and apparatuses for generating an uplink 8-port codebook provided by the present disclosure will be introduced in detail in conjunction with the accompanying drawings.

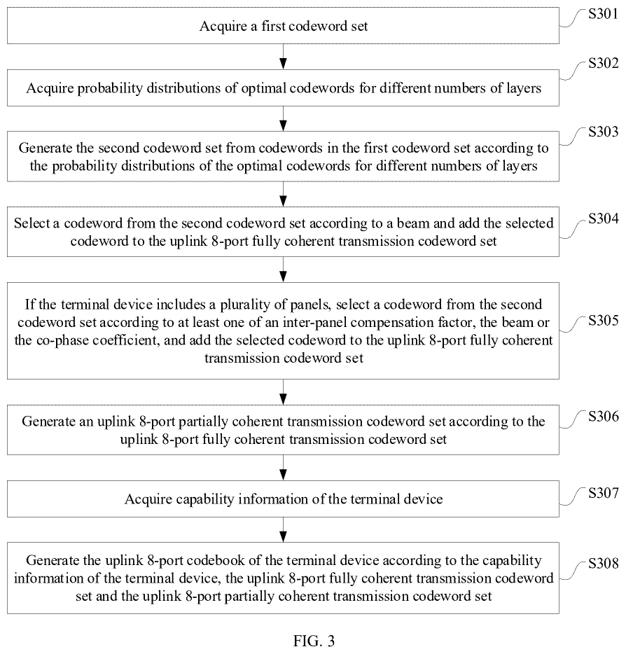

FIG. 2 is a flowchart of a method for generating an uplink 8-port codebook according to an embodiment of the present disclosure, which is performed by a network-side device.

As shown in FIG. 2, the method may include, but is not limited to, the following steps S201-S204.

At step S201, acquiring a first codeword set.

The first codeword set can be used to select partial codewords to generate an initial codeword set for a final codebook. The first codeword set can be, for example, a downlink Type I codebook of R15 version communication protocol, or a codebook obtained by downsampling the downlink Type I codebook of the R15 version communication protocol using selected sampling value(s), or a subset of the above two codebooks, which is not limited.

In an embodiment of the present disclosure, when acquiring the first codeword set, the downlink Type I codebook of the R15 version communication protocol can be obtained as the first codeword set, or an appropriate sampling value can be selected to downsample the downlink Type I codebook of the R15 version communication protocol, and the codebook obtained after downsampling can be used as the first codeword set. Or, a subset of the downlink Type I codebook of the R15 communication protocol can be selected as the first codeword set, and a subset of the codebook obtained by downsampling the downlink Type I codebook of the R15 communication protocol can be selected as the first codeword set, which is not limited.

At step S202, generating a second codeword set according to the first codeword set.

The second codeword set refers to a codeword set composed of some codewords selected from the first codeword set, and the codewords in the first codeword set can be selected according to a probability distribution of optimal codewords to generate the second codeword set.

In an embodiment of the present disclosure, when generating the second codeword set according to the first codeword set, the probability distributions of optimal codewords for different numbers of layers can be statistically determined according to uplink Channel State Information (CSI), and some codewords can be selected from the first codeword set according to the statistically determined probability distributions of optimal codewords to generate the second codeword set. For example, the first codeword set contains K1 codewords. Then K2 codewords can be selected from K1 codewords in the first codeword set according to the probability distributions of optimal codewords, and the selected K2 codewords can be used as the second codeword set, or the second codeword set can be generated according to the first codeword set in any other possible way, which is not limited.

In an embodiment of the present disclosure, after generating the second codeword set according to the first codeword set, an uplink 8-port fully coherent transmission codeword set can be generated according to the second codeword set, as described in subsequent embodiments.

At step S203, generating an uplink 8-port fully coherent transmission codeword set according to the second codeword set.

In an embodiment of the present disclosure, after acquiring the first codeword set and generating the second codeword set according to the first codeword set, an uplink 8-port fully coherent transmission codeword set can be generated according to the second codeword set.

The uplink 8-port fully coherent transmission codeword set refers to a codeword set in a fully coherent transmission scenario, which can be generated by selecting codewords from the second codeword set.

For example, if the second codeword set generated from the first codeword set contains K2 codewords in total, K3 codewords can be determined for the second codeword set to generate an uplink 8-port fully coherent transmission codeword set.

In an embodiment of the present disclosure, when generating the uplink 8-port fully coherent transmission codeword set according to the second codeword set, some parameters can be determined, and according to the determined parameters, the uplink 8-port fully coherent transmission codeword set can be generated according to the second codeword set. These parameters can include, for example, beam(s) and co-phase coefficient(s), etc. Codewords can be selected from the second codeword set according to beams to generate the uplink 8-port fully coherent transmission codeword set, or codewords can be selected from the second codeword set according to co-phase coefficients to generate the uplink 8-port fully coherent transmission codeword set. Or, beams and co-phase coefficients can be combined to select codewords from the second codeword set to generate the uplink 8-port fully coherent transmission codeword set. Any other possible method can also be used to generate the uplink 8-port fully coherent transmission codeword set according to the second codeword set, which is not limited.

At step S204, generating an uplink 8-port codebook of a terminal device according to the uplink 8-port fully coherent transmission codeword set.

The codebook is a shaping method, data can be pre-coded according to the codebook, and the uplink 8-port codebook can support data transmission when the number of ports of the terminal device is extended to 8.

In an embodiment of the present disclosure, after generating the uplink 8-port fully coherent transmission codeword set according to the second codeword set, an uplink 8-port codebook for the terminal device can be generated according to the uplink 8-port fully coherent transmission codeword set.

In an embodiment of the present disclosure, when generating the uplink 8-port codebook for the terminal device according to the uplink 8-port fully coherent transmission codeword set, a partially coherent transmission codebook design scheme can be determined. According to the partially coherent transmission codebook design scheme and the uplink 8-port fully coherent transmission codeword set, a corresponding uplink 8-port partially coherent transmission codeword set can be determined. Then, the capability of the terminal device can be analyzed. If the terminal device supports non-coherent transmission, a diagonal matrix can be used as the uplink 8-port non-coherent transmission codeword set. A union set of the uplink 8-port fully coherent transmission codeword set, partially coherent transmission codeword set, and non-coherent transmission codeword set can then be used as the uplink 8-port codebook under the R18 version communication protocol. If the terminal device does not support non-coherent transmission, the uplink 8-port fully coherent transmission codeword set and partially coherent transmission codeword set can be used as the uplink 8-port codebook under the R18 version communication protocol, to realize the generation of the uplink 8-port codebook of the terminal device according to the uplink 8-port fully coherent transmission codeword set.

In this embodiment, by acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set, the number of codewords in the codebook can be effectively reduced, thereby reducing the overhead of transmit precoding matrix indicator according to the uplink 8-port codebook.

Referring to FIG. 3, FIG. 3 is a flowchart of a method for generating an uplink 8-port codebook according to an embodiment of the present disclosure, which is performed by a network-side device. As shown in FIG. 3, the method may include, but is not limited to, the following steps S301-S308.

At step S301, acquiring a first codeword set.

In some examples, in some embodiments, the first codeword set includes any one of: an R15 downlink Type I codebook; a downsampling codebook generated by performing downsampling on sampling values selected by the R15 downlink Type I codebook; a subset of the R15 downlink Type I codebook; or a subset of the downsampling codebook.

In an embodiment of the present disclosure, when acquiring the first codeword set, any one of the R15 downlink Type I codebook, the downsampling codebook, the subset of the R15 downlink Type I codebook or the subset of the downsampling codebook can be acquired as the first codeword set.

The downsampling codebook is generated by downsampling sampling value(s) selected by the R15 downlink Type I codebook.

In an embodiment of the present disclosure, when selecting sampling values to downsample the R15 downlink Type I codebook to generate the corresponding downsampling codebook, the following two combinations of antenna dimensions and oversampling values can be used to downsample the R15 downlink Type I codebook, where one combination of antenna dimensions and oversampling values is (N1,N2,O1,O2)=(4,1,4,1) and (N1,N2,O1,O2)=(2,2,4,4), and the other combination of antenna dimensions and oversampling values is (N1,N2,O1,O2)=(4,1,2,1) and (N1,N2,O1,O2)=(2, 2, 2, 2), where N1, N2 represent antenna dimensions and O1, O2 represent oversampling values, and the R15 downlink Type I codebook can be downsampled for these two antenna dimensions and oversampling values respectively to generate the corresponding downsampling codebook. For example, when (N1,N2,O1,O2)=(4,1,2,1), the number of codewords K1 in the first codeword set is K1=32.

At step S302, acquiring probability distributions of optimal codewords for different numbers of layers.

Here, the probability distributions of optimal codewords for different numbers of layers can be statistical probability distributions within a period of time domain resources under different system parameters.

In an embodiment of the present disclosure, when acquiring the probability distribution(s) of optimal codewords for different numbers of layers, the network-side device can perform channel estimation using a Sounding Reference Signal (SRS), traverse the codewords in the codebook, calculate channel capacity corresponding to different codewords, and statistically analyze a probability distribution of each codeword being selected as an optimal codeword within a period of time-frequency resources, in order to achieve the acquisition of the probability distributions of optimal codewords for different numbers of layers.

In other embodiments, the network-side device can perform channel estimation using Sounding Reference Signals (SRS). By applying Singular Value Decomposition (SVD), the optimal codeword is obtained. The codewords in the codebook are traversed, and distances between different codewords and the optimal codeword are calculated, which can be represented by the Frobenius (F) norm of matrices. The probability distribution of each codeword being selected as the optimal codeword within a period of time-frequency resources is statistically analyzed, in order to achieve the acquisition of the probability distributions of optimal codewords for different numbers of layers.

At step S303, generating the second codeword set from codewords in the first codeword set according to the probability distributions of the optimal codewords for different numbers of layers.

In an embodiment of the present disclosure, after acquiring the probability distributions of optimal codewords for different numbers of layers as described herein, a second codeword set can be generated from codewords in the first codeword set according to the probability distributions of optimal codewords for different numbers of layers.

In the embodiment of the present disclosure, when generating the second codeword set from codewords in the first codeword set according to the probability distributions of optimal codewords for different numbers of layers, a probability threshold (Pa) can be set. For example, the probability threshold Pa can be set to Pa-0.01%. When the probability of each codeword in the probability distribution is greater than Pa, that codeword is selected for the second codeword set. From a first codeword set K1=32 codewords, K2=16 codewords can be selected to form the second codeword set, thereby generating the second codeword set from codewords in the first codeword set according to the probability distributions of the optimal codewords for different numbers of layers.

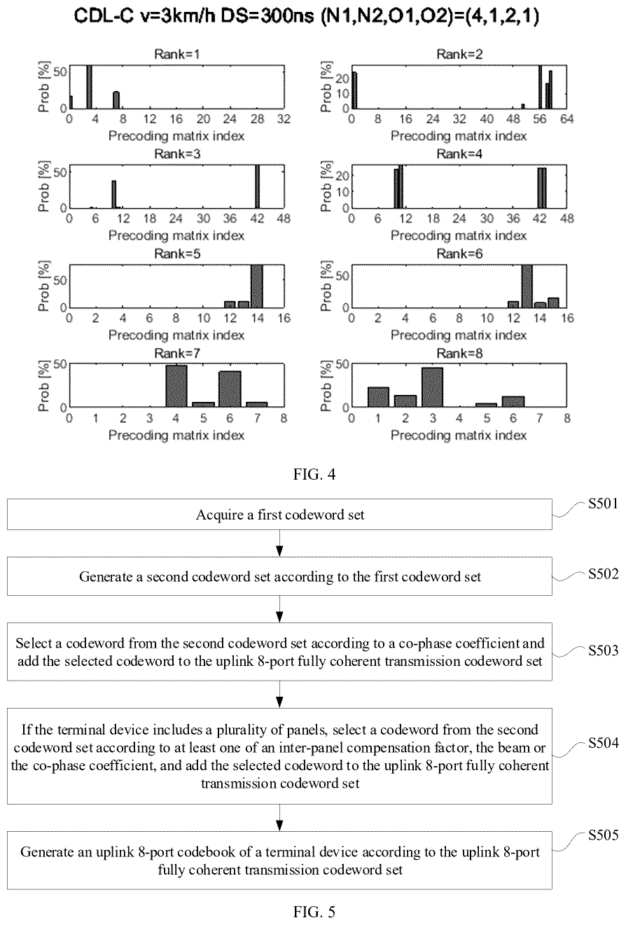

For example, as shown in FIG. 4, which is a probability distribution diagram under a CDL-C channel in an embodiment of the present disclosure, parameters can be adjusted to obtain multiple groups of probability distributions, and the second codeword set can be determined from the first codeword set through the probability distributions. For example, Table 1 below shows codeword sets selected under different system conditions with parameters (N1,N2,O1,O2)=(4,1,2,1), and Table 2 shows codeword sets selected under different system conditions with parameters (N1,N2,O1,O2)=(2,2,2,2).

TABLE 1

| | Total | | | | | | | | | |
|---|---|---|---|---|---|---|---|---|---|---|
| Number of | number of | CDL-A | CDL-A | CDL-A | CDL-B | CDL-B | CDL-B | CDL-C | CDL-C | CDL-C |
| layers | codewords | 3 km/h | 30 km/h | 120 km/h | 3 km/h | 30 km/h | 120 km/h | 3 km/h | 30 km/h | 120 km/h |
| 1 | 32 | 3-4 | 1-4 | 1-4 | 2 | 1 2 | 1-6 | 1 4 8 | 1-4 | 1-5 |
| | | | | | | 29-32 | 29-32 | | 7-8 11 | 7-8 11 |
| | | | | | | | | | 29-32 | 29-32 |
| 2 | 64 | 1 | 1-2 | 1-2 | 1-2 | 1-3 7 | 1-4 | 2 52 | 1-4 7- | 1-4 7- |
| | | | | | 15 | 15-16 | 7-10 | 57 | 10 15- | 10 15- |
| | | | | | | 57-59 | 15-16 51 | 59 | 16 51- | 16 23- |
| | | | | | | | 57-60 | 60 | 52 57- | 24 51- |
| | | | | | | | | | 60 | 52 57- |
| | | | | | | | | | | 60 |
| 3 | 48 | 1 | 1-6 | 1-6 | 5 12 | 1-2 5- | 1-2 5-6 | 6 11- | 1-2 5- | 1-2 5-6 |
| | | | | | 43 | 6 11- | 11-12 | 12 | 6 11- | 11-12 |
| | | | | | | 12 17 | 17 37- | 43 | 12 37 | 17 37 |
| | | | | | | 37-38 | 38 43- | | 43-44 | 43-44 |
| | | | | | | 43-44 | 45 47 | | | |
| 4 | 48 | 1 17 | 1-6 | 1-6 11- | 5 11 | 1-2 5- | 1-2 5-6 | 11-12 | 1-2 5- | 1-2 5-6 |
| | | | 17-18 | 12 17- | 37 | 6 11- | 11-12 | 43-44 | 6 11- | 11-12 |
| | | | 27-28 | 18 27- | 43 | 12 17- | 17-18 | | 12 17- | 17 37- |
| | | | 37-38 | 28 37- | | 18 37- | 21 37- | | 18 37- | 38 43- |
| | | | 43 | 38 43- | | 38 43- | 38 43- | | 38 43- | 44 |
| | | | | 44 | | 44 | 45 | | 44 | |
| 5 | 16 | 13- | 1-2 | 1-2 13- | 13- | 1 11 | 1-2 11- | 13- | 13-16 | 13-16 |
| | | 14 | 13-14 | 14 | 15 | 13-16 | 16 | 15 | | |
| 6 | 16 | 13 | 1 13- | 1-2 9- | 13- | 9-16 | 9 11- | 13- | 13-16 | 13-16 |
| | | | 14 | 10 13- | 14 | | 16 | 16 | | |
| | | | | 14 | | | | | | |
| 7 | 8 | 5 | 1 5-6 | 1-2 5-6 | 5-7 | 13-8 | 1 3-8 | 5-8 | 4-8 | 4-8 |
| 8 | 8 | 1 5 | 1-2 5 | 1-2 5-6 | 1-2 | 1-8 | 1-8 | 2-4 | 1-8 | 1-8 |
| | | | | | 5-6 | | | 6-8 | | |

TABLE 2

| | Total | | | | | | | | | |
|---|---|---|---|---|---|---|---|---|---|---|
| Number of | number of | CDL-A | CDL-A | CDL-A | CDL-B | CDL-B | CDL-B | CDL-C | CDL-C | CDL-C |
| layers | codewords | 3 km/h | 30 km/h | 120 km/h | 3 km/h | 30 km/h | 120 km/h | 3 km/h | 30 km/h | 120 km/h |
| 1 | 64 | 3-4 | 1-4 | 1-4 | 2 | 1-2 4 | 1-4 17- | 1 4 | 1-4 | 1-4 17 |
| | | | | | | 17 49- | 18 21 | 20 | 19-20 | 19-20 |
| | | | | | | 50 52 | 49-52 | | 23-24 | 23-24 |
| | | | | | | 62 63 | 61-63 | | 34-35 | 33-36 |
| | | | | | | | | | 39 49- | 39 49- |
| | | | | | | | | | 50 52 | 52 61- |
| | | | | | | | | | 61-63 | 64 |
| 2 | 128 | 1 | 1-2 | 1-2 | 1-2 | 1-3 7 | 1-4 7 | 1-2 | 1-4 33 | 1-4 33 |
| | | | | | 35 | 35-36 | 33-36 | 68 | 35 65- | 35-36 |
| | | | | | | 47 97- | 47 67 | 97- | 68 93 | 47 65- |
| | | | | | | 98 | 97-100 | 100 | 97- | 68 93 |
| | | | | | | 121- | 121- | | 100 | 97-100 |
| | | | | | | 122 | 122 | | 121- | 121- |
| | | | | | | | | | 122 | 122 |
| | | | | | | | | | 127- | 127- |
| | | | | | | | | | 128 | 128 |
| 3 | 96 | 1 | 1-3 5- | 1-6 | 1-2 | 1-2 5- | 1-2 5-6 | 1-2 | 1-2 | 1-2 25- |
| | | | 6 | | | 6 25- | 25-26 | 25 | 25-26 | 26 36 |
| | | | | | | 26 49 | 49-50 | 73 | 49-50 | 49-50 |
| | | | | | | 73-74 | 73-75 | | 73-74 | 73-74 |
| | | | | | | | 77 93- | | 95 | 95-96 |
| | | | | | | | 95 | | | |
| 4 | 96 | 1 49 | 1-3 5- | 1-6 15- | 1-2 | 1-2 5 | 1-2 5 | 1-2 | 1-2 | 1-2 25- |
| | | | 6 15 | 16 49- | 49- | 25-26 | 25-26 | 26 | 25-26 | 26 35- |
| | | | 49-50 | 50 65- | 50 | 49-50 | 35 49- | 49. | 49-50 | 36 49- |
| | | | 65-66 | 66 | | 65 73- | 50 73- | 50 | 73-74 | 50 73- |
| | | | | | | 74 | 74 95 | 74 | | 74 95- |
| | | | | | | | | | | 96 |
| 5 | 32 | 1-2 | 1-2 | 1-2 17- | 1-2 | 1-2 7 | 1-4 7 | 1-2 | 1-2 10 | 1-2 9- |
| | | | 17-18 | 18 | 9-10 | 9-10 | 9-10 | | | 10 25- |
| | | | | | 17 | 17-18 | 15 17- | | | 26 |
| | | | | | | 25-26 | 18 25- | | | |
| | | | | | | 31-32 | 26 31- | | | |
| | | | | | | | 32 | | | |
| 6 | 32 | 17 | 1 17- | 1-2 17- | 1-2 | 1-2 9- | 1-2 9- | 1-2 | 1-2 9- | 1-2 9- |
| | | | 18 | 18 21- | | 10 17 | 10 17- | | 10 | 10 |
| | | | | 22 | | 25 | 18 25 | | | |
| 7 | 32 | 22 | 1 5-6 | 1-2 5-6 | 5 21- | 5-6 9 | 1-2 5-6 | 21- | 21-22 | 5-6 21- |
| | | | 21-22 | 21-22 | 22 | 11-14 | 9 11- | 22 | 29-30 | 22 29- |
| | | | | | 29- | 17 21- | 14 17- | | | 30 |
| | | | | | 30 | 22 25 | 18 21- | | | |
| | | | | | | 29-31 | 22 25 | | | |
| | | | | | | | 29-32 | | | |
| 8 | 32 | 1-2 | 1-2 5- | 1-2 5-6 | 1-2 | 1-2 5- | 1-2 5-6 | 1-2 | 1-2 5- | 1-2 5-6 |
| | | 5-6 | 6 17- | 17-18 | 5-6 9 | 69-10 | 8-10 | 5-6 | 69-10 | 9-10 |
| | | 17- | 18 21- | 21-22 | 13- | 13-14 | 13-14 | 17- | 13 17- | 17-18 |
| | | 18 | 22 | | 14 | 17-18 | 17-18 | 18 | 18 21- | 21-22 |
| | | 21- | | | 17- | 21-22 | 21-22 | 21- | 22 25- | 26 29 |
| | | 22 | | | 18 | 24-26 | 25-26 | 22 | 26 | |
| | | | | | 21- | 29-30 | 29-31 | | | |
| | | | | | 22 | | | | | |
| | | | | | 25 | | | | | |
| | | | | | 29- | | | | | |
| | | | | | 30 | | | | | |

At step S304, selecting a codeword from the second codeword set according to a beam and adding the selected codeword to the uplink 8-port fully coherent transmission codeword set.

In an embodiment of the present disclosure, after generating the second codeword set from codewords in the first codeword set according to the probability distributions of the optimal codewords for different numbers of layers as described, codeword(s) can be selected from the second codeword set according to a beam and added to the uplink 8-port fully coherent transmission codeword set.

In the embodiment of the present disclosure, when generating the uplink 8-port fully coherent transmission codeword set, a codeword can be selected from the second codeword set according to the beam, and the codeword can be selected from the second codeword set by comparing probability. Codewords for the same beam correspond to the same direction, so codewords corresponding to the same beam can be selected and added to the uplink 8-port fully coherent transmission codeword set.

For example, the beam can be selected preferentially, i.e., a codeword corresponding to i1,1={0,1} can be selected preferentially.

At step S305, in response to the terminal device including a plurality of panels, selecting a codeword from the second codeword set according to at least one of an inter-panel compensation factor, the beam or the co-phase coefficient, and adding the selected codeword to the uplink 8-port fully coherent transmission codeword set.

In the embodiment of the present disclosure, when the terminal device includes multiple panels, the inter-panel compensation factor of the terminal device can be obtained, and then a codeword can be selected from the second codeword set according to at least one of the inter-panel compensation factor, the beam or the co-phase coefficient, i.e., any one can be selected from the inter-panel compensation factor, the beam and the co-phase coefficient, or a codeword selection strategy can be formed by combining the three factors. A codeword is selected from the second codeword set according to the codeword selection strategy, and the selected codeword is added to the uplink 8-port fully coherent transmission codeword set, thereby generating the uplink 8-port fully coherent transmission codeword set according to the second codeword set.

At step S306, generating an uplink 8-port partially coherent transmission codeword set according to the uplink 8-port fully coherent transmission codeword set.

The uplink 8-port partially coherent transmission codeword set refers to a codeword set in a partially coherent transmission scenario, which can be generated according to the uplink 8-port fully coherent transmission codeword set.

In the embodiment of the present disclosure, when generating the uplink 8-port partially coherent transmission codeword set according to the uplink 8-port fully coherent transmission codeword set, the corresponding uplink 8-port partially coherent transmission codeword set can be determined according to the uplink 8-port fully coherent transmission codeword set and the partially coherent transmission codebook design scheme.

At step S307, acquiring capability information of the terminal device.

The capability information of the terminal device refers to communication information that can indicate whether the terminal device supports non-coherent transmission. The capability information of the terminal device can indicate that the terminal device supports non-coherent transmission or does not support non-coherent transmission, and the capability information of the terminal device can be used in generating the uplink 8-port codebook of the terminal device.

In an embodiment of the present disclosure, when acquiring the capability information of the terminal device, whether the terminal device supports non-coherent transmission can be analyzed to obtain whether the terminal device supports non-coherent transmission or not, and the communication information generated by the analysis result can be taken as the capability information of the terminal device.

In an embodiment of the present disclosure, after acquiring the capability information of the terminal device, the uplink 8-port codebook of the terminal device can be generated according to the capability information of the terminal device, the uplink 8-port fully coherent transmission codeword set and the uplink 8-port partially coherent transmission codeword set, as shown in the subsequent embodiments for details.

At step S308, generating the uplink 8-port codebook of the terminal device according to the capability information of the terminal device, the uplink 8-port fully coherent transmission codeword set and the uplink 8-port partially coherent transmission codeword set.

In an embodiment of the present disclosure, when generating the uplink 8-port codebook of the terminal device according to the capability information of the terminal device, the uplink 8-port fully coherent transmission codeword set and the uplink 8-port partially coherent transmission codeword set, the capability information of the terminal device can be analyzed to obtain whether the terminal device supports non-coherent transmission, and if the capability information indicates that the terminal device supports non-coherent transmission, a diagonal matrix is taken as the uplink 8-port non-coherent transmission codeword set, and a union set of the uplink 8-port fully coherent transmission codeword set, partially coherent transmission codeword set and non-coherent transmission codeword set is taken as the R18 uplink 8-port codebook. If the capability information indicates that the terminal device does not support non-coherent transmission, it is unnecessary to acquire the uplink 8-port non-coherent transmission codeword set, and the uplink 8-port fully coherent transmission codeword set and partially coherent transmission codeword set will be taken as the uplink 8-port codebook.

Or, other possible ways can be adopted to generate the uplink 8-port codebook of the terminal device according to the capability information of the terminal device, the uplink 8-port fully coherent transmission codeword set and the uplink 8-port partially coherent transmission codeword set, and there is no restriction on this.

In this embodiment, by acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set, the number of codewords in the codebook can be effectively reduced, thereby reducing the overhead of transmit precoding matrix indicator according to the uplink 8-port codebook. By acquiring any one of: an R15 downlink Type I codebook; a downsampling codebook generated by performing downsampling on sampling values selected by the R15 downlink Type I codebook; a subset of the R15 downlink Type I codebook; and a subset of the downsampling codebook, and taken as the first codeword set.

Referring to FIG. 5, FIG. 5 is a flowchart of a method for generating an uplink 8-port codebook according to an embodiment of the present disclosure, which is performed by a network-side device. As shown in FIG. 5, the method may include, but is not limited to, the following steps S501-S505.

At step S501, acquiring a first codeword set.

At step S502, generating a second codeword set according to the first codeword set.

The detailed description of step S501 and step S502 can be described with reference to the embodiments, and the embodiment of the present disclosure will not be repeated here.

At step S503, selecting a codeword from the second codeword set according to a co-phase coefficient and adding the selected codeword to the uplink 8-port fully coherent transmission codeword set.

In an embodiment of the present disclosure, when generating the uplink 8-port fully coherent transmission codeword set according to the second codeword set, the co-phase coefficient can be obtained, and the codeword is selected from the second codeword set according to the co-phase coefficient, i.e., the codeword corresponding to i2={0} is preferentially selected, and the selected codeword is added to the uplink 8-port fully coherent transmission codeword set.

At step S504, in response to the terminal device including a plurality of panels, selecting a codeword from the second codeword set according to at least one of an inter-panel compensation factor, the beam or the co-phase coefficient, and adding the selected codeword to the uplink 8-port fully coherent transmission codeword set.

At step S505, generating an uplink 8-port codebook of a terminal device according to the uplink 8-port fully coherent transmission codeword set.

The detailed description of step S504 and step S505 can be described with reference to the embodiments, and the embodiment of the present disclosure will not be repeated here.

In this embodiment, by acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set, the number of codewords in the codebook can be effectively reduced, thereby reducing the overhead of transmit precoding matrix indicator according to the uplink 8-port codebook. By selecting codeword(s) from the second codeword set according to the co-phase coefficient and adding the selected codeword(s) to the uplink 8-port fully coherent transmission codeword set, an additional generation mode of the uplink 8-port fully coherent transmission codeword set can be provided, and the generation effect of the uplink 8-port fully coherent transmission codeword set can be improved.

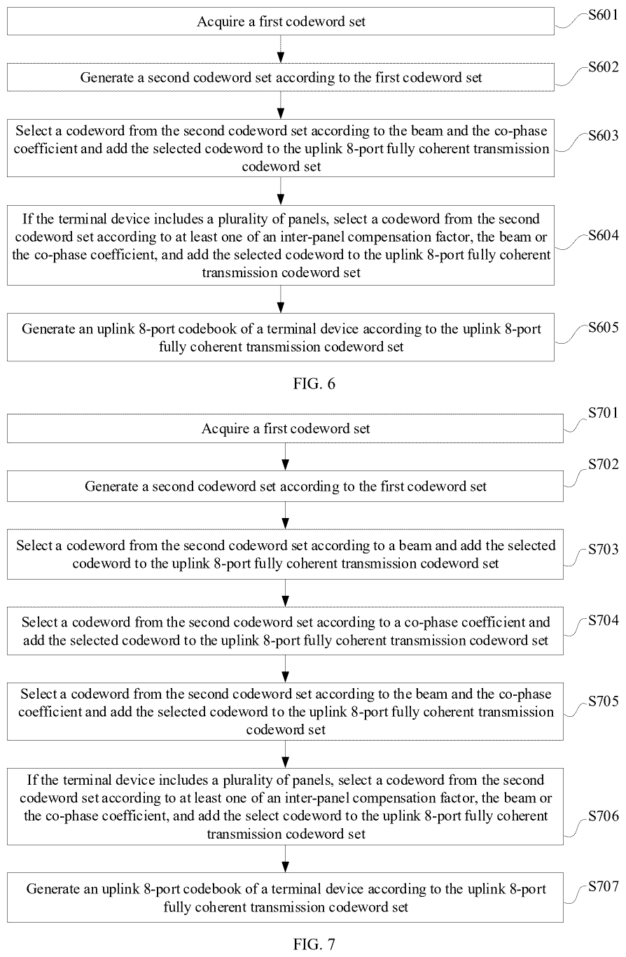

Referring to FIG. 6, FIG. 6 is a flowchart of a method for generating an uplink 8-port codebook according to an embodiment of the present disclosure, which is performed by a network-side device. As shown in FIG. 6, the method may include, but is not limited to, the following steps S601-S605.

At step S601, acquiring a first codeword set.

At step S602, generating a second codeword set according to the first codeword set.

The detailed description of step S601 and step S602 can be described with reference to the embodiments, and the embodiment of the present disclosure will not be repeated here.

At step S603, selecting a codeword from the second codeword set according to the beam and the co-phase coefficient and adding the selected codeword to the uplink 8-port fully coherent transmission codeword set.

In an embodiment of the present disclosure, when generating the uplink 8-port fully coherent transmission codeword set according to the second codeword set, the beam and the co-phase coefficient can be obtained, and a codeword is selected from the second codeword set according to the beam and co-phase coefficient, and the beam and co-phase coefficient are jointly considered, i.e., codewords corresponding to i1,1={0} and i2={0} are preferentially considered, and the selected codewords are added to the uplink 8-port fully coherent transmission codeword set.

At step S604, in response to the terminal device including a plurality of panels, selecting a codeword from the second codeword set according to at least one of an inter-panel compensation factor, the beam or the co-phase coefficient, and adding the selected codeword to the uplink 8-port fully coherent transmission codeword set.

At step S605, generating an uplink 8-port codebook of a terminal device according to the uplink 8-port fully coherent transmission codeword set.

The detailed description of step S604 and step S605 can be described with reference to the embodiments, and the embodiment of the present disclosure will not be repeated here.

In this embodiment, by acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set, the number of codewords in the codebook can be effectively reduced, thereby reducing the overhead of transmit precoding matrix indicator according to the uplink 8-port codebook. By selecting codeword(s) from the second codeword set according to the beam and the co-phase coefficient and adding the selected codeword(s) to the uplink 8-port fully coherent transmission codeword set, a more reliable generation method of uplink 8-port fully coherent transmission codeword set can be provided by improving the complexity of codeword selection, and the performance of codewords in the uplink 8-port fully coherent transmission codeword set can be improved.

Referring to FIG. 7, FIG. 7 is a flowchart of a method for generating an uplink 8-port codebook according to an embodiment of the present disclosure, which is performed by a network-side device. As shown in FIG. 7, the method may include, but is not limited to, the following steps S701-S707.

At step S701, acquiring a first codeword set.

At step S702, generating a second codeword set according to the first codeword set.

At step S703, selecting a codeword from the second codeword set according to a beam and adding the selected codeword to the uplink 8-port fully coherent transmission codeword set.

At step S704, selecting a codeword from the second codeword set according to a co-phase coefficient and adding the selected codeword to the uplink 8-port fully coherent transmission codeword set.

The detailed description of step S701 to step S704 can be described with reference to the embodiments, and the embodiment of the present disclosure will not be repeated here.

At step S705, selecting a codeword from the second codeword set according to the beam and the co-phase coefficient and adding the selected codeword to the uplink 8-port fully coherent transmission codeword set.

It should be noted that the two most important quantities in the codebook design of downlink Type I of R15 communication protocol are the beam and the co-phase coefficient, in which the beam is the most important, and the codewords of the same beam correspond to the same direction, which is more conducive to adapting to the current channel. Therefore, when generating the uplink 8-port fully coherent transmission codeword set, the beam can be preferentially selected to select codewords from the first codeword set to generate the second codeword set.

At step S706, in response to the terminal device including a plurality of panels, selecting a codeword from the second codeword set according to at least one of an inter-panel compensation factor, the beam or the co-phase coefficient, and adding the selected codeword to the uplink 8-port fully coherent transmission codeword set.

In an embodiment of the present disclosure, when generating the uplink 8-port fully coherent transmission codeword set according to the second codeword set, at least one of the following ways can be selected to generate the uplink 8-port fully coherent transmission codeword set: selecting a codeword from the second codeword set according to a beam and adding the selected codeword to the uplink 8-port fully coherent transmission codeword set; selecting a codeword from the second codeword set according to a co-phase coefficient and adding the selected codeword to the uplink 8-port fully coherent transmission codeword set; selecting a codeword from the second codeword set according to the beam and the co-phase coefficient and adding the selected codeword to the uplink 8-port fully coherent transmission codeword set; or in response to the terminal device including a plurality of panels, selecting a codeword from the second codeword set according to at least one of an inter-panel compensation factor, the beam or the co-phase coefficient, and adding the selected codeword to the uplink 8-port fully coherent transmission codeword set, where the fourth strategy is only applicable to multi-panel codebook design. In other words, any one or any combination of the four strategies can be selected for generating the uplink 8-port fully coherent transmission codeword set, resulting in the corresponding uplink 8-port fully coherent transmission codeword set.

For example, by comparing probabilities, the following codewords can be selected to form the third codeword set, as shown in Table 3 below. Table 3 illustrates the uplink 8-port fully coherent transmission codeword set generated by selecting codewords from the second codeword set under different system conditions with the parameters (N1,N2,O1,O2)=(4,1,2,1).

TABLE 3

| | Number of | Number of | | Select |
|---|---|---|---|---|
| Number of | Type I | selected | | codeword |
| layers | codewords | codewords | Corresponding coefficients | index |
| 1 | 32 | 12 | {i_{1, 1} = 0, 1, 7, i_{1, 2} = 0, i₂ = 0, 1, 2, 3} | 1-8 29-32 |
| 2 | 64 | 12 | {i_{1, 1} = 0, 1, i_{1, 2} = 0, i_{1, 3} = 0, 3, i₂ = 0, 1} | 1-2 7-8 9-10 |
| | | | {i_{1, 1} = 7, i_{1, 2} = 0, i_{1, 3} = 0, 1, i₂ = 0, 1} | 15-16 57-60 |
| 3 | 48 | 8 | {i_{1, 1} = 0, i_{1, 2} = 0, i_{1, 3} = 0, 2, i₂ = 0, 1} | 1-2 5-6 11-12 |
| | | | {i_{1, 1} = 1, i_{1, 2} = 0, i_{1, 3} = 2, i₂ = 0, 1} | 43-44 |
| | | | {i_{1, 1} = 7, i_{1, 2} = 0, i_{1, 3} = 0, i₂ = 0, 1} | |
| 4 | 48 | 8 | {i_{1, 1} = 0, i_{1, 2} = 0, i_{1, 3} = 0, 2, i₂ = 0, 1} | 1-2 5-6 11-12 |
| | | | {i_{1, 1} = 1, i_{1, 2} = 0, i_{1, 3} = 2, i₂ = 0, 1} | 43-44 |
| | | | {i_{1, 1} = 7, i_{1, 2} = 0, i_{1, 3} = 0, i₂ = 0, 1} | |
| 5 | 16 | 4 | {i_{1, 1} = 0, i_{1, 2} = 0, i₂ = 0, 1} | 1-2 13 15 |
| | | | {i_{1, 1} = 6, 7, i_{1, 2} = 0, i₂ = 0} | |
| 6 | 16 | 4 | {i_{1, 1} = 0, i₁₂ = 0, i₂ = 0, 1} | 1-2 13 15 |
| | | | {i_{1, 1} = 6, 7, i_{1, 2} = 0, i₂ = 0} | |
| 7 | 8 | 2 | {i_{1, 1} = 0, 2, i_{1, 2} = 0, i₂ = 0} | 1 5 |
| 8 | 8 | 2 | {i_{1, 1} = 0, 2, i_{1, 2} = 0, i₂ = 0} | 1 5 |

For example, by comparing probabilities, the following codewords can be selected to form the third codeword set, as shown in Table 4 below. Table 4 illustrates the uplink 8-port fully coherent transmission codeword set generated by selecting codewords from the second codeword set under different system conditions with the parameters (N1,N2,O1,O2)=(2,2,2,2).

TABLE 4

| | Number of | Number of | | |
|---|---|---|---|---|
| Number of | Type I | selected | | |
| layers | codewords | codewords | Corresponding coefficients | Select codeword index |
| 1 | 64 | 16 | {i_{1, 1} = 0, 1, 3 i_{1, 2} = 0, i₂ = 0, 1, 2, 3} | 1-4 17-20 49-52 61-64 |
| | | | {i_{1, 1} = 3 i_{1, 2} = 3, i₂ = 0, 1, 2, 3} | |
| 2 | 128 | 12 | {i_{1, 1} = 0, 3 i_{1, 2} = 0, i_{1, 3} = 0, i₂ = 0, 1} | 1-2 35-36 67-68 97-98 |
| | | | {i_{1, 1} = 1, 2 i_{1, 2} = 0, i_{1, 3} = 1, i₂ = 0, 1} | 121-122 127-128 |
| | | | {i_{1, 1} = 3 i_{1, 2} = 3, i_{1, 3} = 0, 3 i₂ = 0, 1} | |
| 3 | 96 | 8 | {i_{1, 1} = 0, 1, 2, 3, i_{1, 2} = 0, i_{1, 3} = 0, i₂ = 0, 1} | 1-2 25-26 49-50 73-74 |
| 4 | 96 | 8 | {i_{1, 1} = 0, 1, 2, 3, i_{1, 2} = 0, i_{1, 3} = 0, i₂ = 0, 1} | 1-2 25-26 49-50 73-74 |
| 5 | 32 | 4 | {i_{1, 1} = 0, 1, 2, 3 i_{1, 2} = 0, i₂ = 0} | 1 9 17 25 |
| 6 | 32 | 4 | {i_{1, 1} = 0, 1, 2, 3 i_{1, 2} = 0, i₂ = 0} | 1 9 17 25 |
| 7 | 32 | 2 | {i_{1, 1} = 0, i_{1, 2} = 0, i₂ = 0} | 1 21 |
| | | | {i_{1, 1} = 2, i_{1, 2} = 2, i₂ = 0} | |
| 8 | 32 | 2 | {i_{1, 1} = 0, i_{1, 2} = 0, i₂ = 0} | 1 21 |
| | | | {i_{1, 1} = 2, i_{1, 2} = 2, i₂ = 0} | |

At step S707, generating an uplink 8-port codebook of a terminal device according to the uplink 8-port fully coherent transmission codeword set.

The detailed description of step S707 can be described with reference to the embodiments, and the embodiment of the present disclosure will not be repeated here.

In this embodiment, by acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set, the number of codewords in the codebook can be effectively reduced, thereby reducing the overhead of transmit precoding matrix indicator according to the uplink 8-port codebook. Generating the uplink 8-port fully coherent transmission codeword set according to at least one of the following second codeword sets: selecting a codeword from the second codeword set according to a beam and adding the selected codeword to the uplink 8-port fully coherent transmission codeword set; selecting a codeword from the second codeword set according to a co-phase coefficient and adding the selected codeword to the uplink 8-port fully coherent transmission codeword set; selecting a codeword from the second codeword set according to the beam and the co-phase coefficient and adding the selected codeword to the uplink 8-port fully coherent transmission codeword set; or in response to the terminal device including a plurality of panels, selecting a codeword from the second codeword set according to at least one of an inter-panel compensation factor, the beam or the co-phase coefficient, and adding the selected codeword to the uplink 8-port fully coherent transmission codeword set. By considering the design scenario of multi-panel codebooks, the integrity of the uplink 8-port codebook generation method proposed in this embodiment can be ensured, making the generation of the uplink 8-port codebook applicable to various usage scenarios and effectively expanding the applicability of the uplink 8-port codebook generation method.

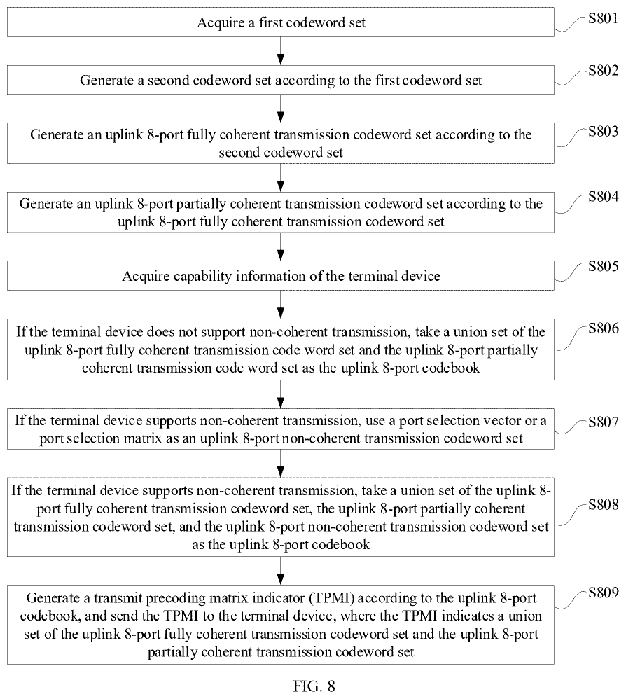

Referring to FIG. 8, FIG. 8 is a flowchart of a method for generating an uplink 8-port codebook according to an embodiment of the present disclosure, which is performed by a network-side device. As shown in FIG. 8, the method may include, but is not limited to, the following steps S801-S809.

At step S801, acquiring a first codeword set.

At step S802, generating a second codeword set according to the first codeword set.

At step S803, generating an uplink 8-port fully coherent transmission codeword set according to the second codeword set.

At step S804, generating an uplink 8-port partially coherent transmission codeword set according to the uplink 8-port fully coherent transmission codeword set.

At step S805, acquiring capability information of the terminal device.

The detailed description of step S801 to step S805 can be described with reference to the embodiments, and the embodiment of the present disclosure will not be repeated here.

At step S806, in response to the terminal device not supporting non-coherent transmission, taking a union set of the uplink 8-port fully coherent transmission codeword set and the uplink 8-port partially coherent transmission codeword set as the uplink 8-port codebook.

In an embodiment of the present disclosure, the capability information of the terminal device can be analyzed. If the capability information of the terminal device indicates that the terminal device does not support non-coherent transmission, the uplink 8-port non-coherent transmission codeword set will not be obtained, and a union set of uplink 8-port fully coherent transmission codeword set and uplink 8-port partially coherent transmission codeword set is taken as the uplink 8-port codebook.

At step S807, in response to the terminal device supporting non-coherent transmission, using a port selection vector or a port selection matrix as an uplink 8-port non-coherent transmission codeword set.

In an embodiment of the present disclosure, the capability information of the terminal device can be analyzed. If the capability information of the terminal device indicates that the terminal device supports non-coherent transmission, the port selection vector or the port selection matrix is used as the uplink 8-port non-coherent transmission codeword set, where when the number of layers is 1, the selection vector is used as the uplink 8-port non-coherent transmission codeword set, and when the number of layers is greater than 1, the selection matrix is used as the uplink 8-port non-coherent transmission codeword set.

At step S808, in response to the terminal device supporting non-coherent transmission, taking a union set of the uplink 8-port fully coherent transmission codeword set, the uplink 8-port partially coherent transmission codeword set, and the uplink 8-port non-coherent transmission codeword set as the uplink 8-port codebook.

In an embodiment of the present disclosure, after using the port selection vector or the port selection matrix as an uplink 8-port non-coherent transmission codeword set when the terminal device supports non-coherent transmission, the union set of the uplink 8-port fully coherent transmission codeword set, the uplink 8-port partially coherent transmission codeword set, and the uplink 8-port incoherent transmission codeword set is taken as the uplink 8-port codebook.

In an embodiment of the present disclosure, by using the port selection vector or the port selection matrix as an uplink 8-port non-coherent transmission codeword set when the terminal device supports non-coherent transmission, and taking the union set of the uplink 8-port fully coherent transmission codeword set, the uplink 8-port partially coherent transmission codeword set, and the uplink 8-port incoherent transmission codeword set as the uplink 8-port codebook, the capability of the terminal device can be analyzed, and the uplink 8-port codebook design can be carried out separately for cases where the terminal device supports or does not support non-coherent transmission, thus ensuring the accuracy and robustness of the design of the uplink 8-port codebook.

At step S809, generating a transmit precoding matrix indicator (TPMI) according to the uplink 8-port codebook, and sending the TPMI to the terminal device, where the TPMI indicates a union set of the uplink 8-port fully coherent transmission codeword set and the uplink 8-port partially coherent transmission codeword set.

The terminal device can determine the number of layers and the precoding matrix for uplink transmission according to the TPMI and the number of transmission layers, and then perform precoding and transmit data.

In an embodiment of the present disclosure, after generating the uplink 8-port codebook of the terminal device according to the uplink 8-port fully coherent transmission codeword set described, a transmit precoding matrix indicator (TPMI) can be generated according to the uplink 8-port codebook, and the TPMI is sent to the terminal device to indicate the codeword to the terminal device.

In an embodiment of the present disclosure, the TPMI indicates the union set of the uplink 8-port fully coherent transmission codeword set and the uplink 8-port partially coherent transmission codeword set, under the communication scenario where the terminal device does not support non-coherent transmission.

In this embodiment, by acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set, the number of codewords in the codebook can be effectively reduced, thereby reducing the overhead of transmit precoding matrix indicator according to the uplink 8-port codebook. By using the port selection vector or the port selection matrix as an uplink 8-port non-coherent transmission codeword set when the terminal device supports non-coherent transmission, and taking the union set of the uplink 8-port fully coherent transmission codeword set, the uplink 8-port partially coherent transmission codeword set, and the uplink 8-port incoherent transmission codeword set as the uplink 8-port codebook, the capability of the terminal device can be analyzed, and the uplink 8-port codebook design can be carried out separately for cases where the terminal device supports or does not support non-coherent transmission, thus ensuring the accuracy and robustness of the design of the uplink 8-port codebook.

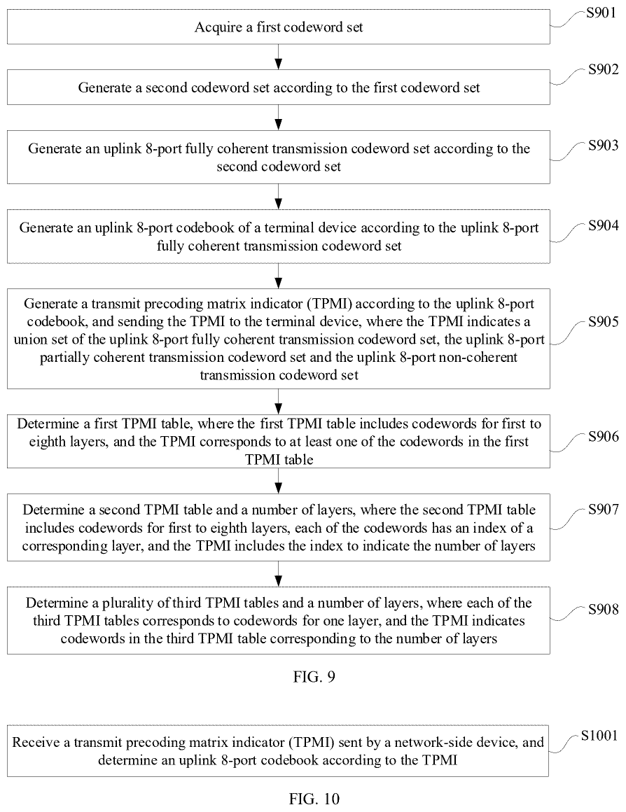

Referring to FIG. 9, FIG. 9 is a flowchart of a method for generating an uplink 8-port codebook according to an embodiment of the present disclosure, which is performed by a network-side device. As shown in FIG. 9, the method may include, but is not limited to, the following steps S901-S908.

At step S901, acquiring a first codeword set.

At step S902, generating a second codeword set according to the first codeword set.

At step S903, generating an uplink 8-port fully coherent transmission codeword set according to the second codeword set.

At step S904, generating an uplink 8-port codebook of a terminal device according to the uplink 8-port fully coherent transmission codeword set.

The detailed description of step S901 to step S904 can be described with reference to the embodiments, and the embodiment of the present disclosure will not be repeated here.

At step S905, generating a transmit precoding matrix indicator (TPMI) according to the uplink 8-port codebook, and sending the TPMI to the terminal device, where the TPMI indicates a union set of the uplink 8-port fully coherent transmission codeword set, the uplink 8-port partially coherent transmission codeword set and the uplink 8-port non-coherent transmission codeword set.

In an embodiment of the present disclosure, after generating the uplink 8-port codebook of the terminal device according to the uplink 8-port fully coherent transmission codeword set described, a transmit precoding matrix indicator (TPMI) can be generated according to the uplink 8-port codebook, and the TPMI is sent to the terminal device to indicate the codeword to the terminal device.

In an embodiment of the present disclosure, the TPMI indicates the union set of the uplink 8-port fully coherent transmission codeword set, the uplink 8-port partially coherent transmission codeword set and the uplink 8-port non-coherent transmission codeword set, under the communication scenario where the terminal device supports non-coherent transmission.

At step S906, determining a first TPMI table, where the first TPMI table includes codewords for first to eighth layers, and the TPMI corresponds to at least one of the codewords in the first TPMI table.

The first TPMI table includes codewords for first to eighth layers, and TPMI corresponds to at least one of the codewords in the first TPMI table, and the first TPMI table may be used to indicate specific codeword(s) corresponding to an index.

In an embodiment of the present disclosure, the TPMI table contains all codewords for layers 1 to 8, and the codewords are indicated by TPMI, for example, 6, 7 or 8 bits.

At step S907, determining a second TPMI table and a number of layers, where the second TPMI table includes codewords for first to eighth layers, each of the codewords for a layer corresponds to an index, and the TPMI indicates the index within the number of layers.

The second TPMI table includes codewords for first to eighth layers, each of the codewords for a layer corresponds to an index, and the TPMI indicates the index within the number of layers.

In the embodiment of the present disclosure, the TPMI table contains all codewords for layers 1 to 8, and an index is set separately for the codewords of each layer, and the codewords are indicated from the codewords of the corresponding layers according to the indicated number of layers.

At step S908, determining a plurality of third TPMI tables and a number of layers, where each of the third TPMI tables corresponds to codewords for one layer, and the TPMI indicates codewords in the third TPMI tables corresponding to the number of layers.

Each of the third TPMI tables corresponds to codewords of one layer, and the TPMI indicates codewords in the third TPMI tables corresponding to the number of layers.

In an embodiment of the present disclosure, a TPMI table can be designed for codewords of each layer, and according to the indicated number of layers, codewords can be indicated from the TPMI tables corresponding to the number of layers.

It should be noted that there are three TPMI indication ways proposed in the implementations of the present disclosure: determining a first TPMI table, where the first TPMI table includes codewords for first to eighth layers, and the TPMI corresponds to at least one of the codewords in the first TPMI table; determining a second TPMI table and a number of layers, where the second TPMI table includes codewords for first to eighth layers, each of the codewords for a layer corresponds to an index, and the TPMI indicates the index within the number of layers; and determining a plurality of third TPMI tables and a number of layers, where each of the third TPMI tables corresponds to codewords for one layer, and the TPMI indicates codewords in the third TPMI tables corresponding to the number of layers, and at least one of three ways is adopted, i.e., any one of the three ways can be adopted, or any several of the three ways can be adopted, which is not limited.

In an implementation of the present disclosure, the number of codewords of different coherence types, the total number of codewords, and the number of TPMI bits for an 8-port codebook can be summarized as shown in Table 5 below:

TABLE 5

| Number of layers | 1 | 2 | 3 | 4 | 5 | 6 | 7 | 8 |
|---|---|---|---|---|---|---|---|---|
| Fully coherent | 28 | 24 | 16 | 16 | 8 | 8 | 4 | 4 |
| Partially coherent | 28 | 24 | 16 | 16 | 8 | 8 | 4 | 4 |
| Non-coherent | 8 | 8 | 1 | 1 | 1 | 1 | 1 | 1 |
| Total | 64 | 56 | 33 | 33 | 17 | 17 | 9 | 9 |

| | | | |
|---|---|---|---|
| Total number of codewords | 238 | TPMI | 8 |

As shown in Table 5, if one TPMI table is used, there are a total of 238 codewords, and an 8-bit TPMI can be employed for indication. If eight TPMI tables are used, different numbers of TPMI bits are required for each layer. For example, when there are two layers with a total of 56 codewords, a 6-bit TPMI is necessary.

In addition, if 8-bit TPMI is used, another possible implementation of the number of codewords of different coherence types, the total number of codewords, and the number of TPMI bits for an 8-port codebook can be summarized as shown in Table 6 below:

TABLE 6

| Number of layers | 1 | 2 | 3 | 4 | 5 | 6 | 7 | 8 |
|---|---|---|---|---|---|---|---|---|
| Fully coherent | 32 | 32 | 16 | 16 | 8 | 8 | 4 | 4 |
| Partially coherent | 32 | 32 | 16 | 16 | 8 | 8 | 4 | 4 |
| Non-coherent | 8 | 1 | 1 | 1 | 1 | 1 | 1 | 1 |
| Total | 72 | 65 | 33 | 33 | 17 | 17 | 9 | 9 |

| | | | |
|---|---|---|---|
| Total number of codewords | 255 | TPMI | 8 |

At this time, the total number of codewords is 255, which requires 8-bit indication.

In this embodiment, by acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set, the number of codewords in the codebook can be effectively reduced, thereby reducing the overhead of transmit precoding matrix indicator according to the uplink 8-port codebook.

Referring to FIG. 10, FIG. 10 is a flowchart of a method for generating an uplink 8-port codebook according to an embodiment of the present disclosure, which is performed by a terminal device.

The method for generating the uplink 8-port codebook in this embodiment may be performed by a terminal device, such as a cellular phone, or a tablet or a smartwatch having a mobile communication function, etc., and there is no restriction on this.

As shown in FIG. 10, the method may include, but is not limited to, the following step, S1001.

At step S1001, receiving a transmit precoding matrix indicator (TPMI) sent by a network-side device, and determining an uplink 8-port codebook according to the TPMI.

In the embodiment of the present disclosure, after the network-side device generates the TPMI according to the uplink 8-port codebook, and the terminal device sends the TPMI, the terminal device can receive the TPMI sent by the network-side device, and determine the uplink 8-port codebook according to the instruction of the TPMI.

In this embodiment, by receiving the TPMI sent by the network-side device and determining the uplink 8-port codebook according to the TPMI, the uplink 8-port codebook can be determined according to the TPMI sent by the network-side device, so as to ensure that the terminal side can determine the number of layers and the precoding matrix for uplink transmission according to the TPMI and the number of transmission layers, and then perform precoding and transmit data.

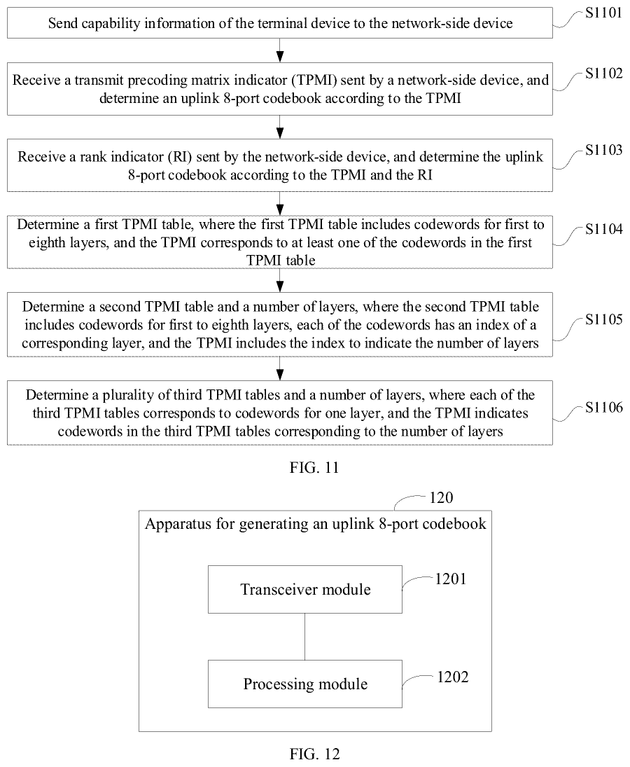

Referring to FIG. 11, FIG. 11 is a flowchart of a method for generating an uplink 8-port codebook according to an embodiment of the present disclosure, which is performed by a network-side device. As shown in FIG. 11, the method may include, but is not limited to, the following steps S1101-S1106.

At step S1101, sending capability information of the terminal device to the network-side device.

The capability information of the terminal device refers to communication information that can indicate whether the terminal device supports non-coherent transmission. The capability information of the terminal device can indicate that the terminal device supports non-coherent transmission or does not support non-coherent transmission, and the capability information of the terminal device can participate in the process of generating the uplink 8-port codebook of the terminal device.

In the embodiment of the present disclosure, the terminal device can generate the capability information of the terminal device according to whether it supports non-coherent transmission, and then transmit the capability information of the terminal device to the network-side device, and the network-side device receives the capability information of the terminal device.

At step S1102, receiving a transmit precoding matrix indicator (TPMI) sent by a network-side device, and determining an uplink 8-port codebook according to the TPMI.

At step S1103, receiving a rank indicator (RI) sent by the network-side device, and determining the uplink 8-port codebook according to the TPMI and the RI.

The RI is used to determine the number of transmission layers, and the uplink 8-port codebook can be determined according to the TPMI and the RI.

In the embodiment of the present disclosure, the TPMI and the RI sent by the network-side device can be received. The uplink 8-port codebook is determined according to the TPMI and the RI, where the RI determines the number of transmission layers and the TPMI indicates the precoding matrix.

At step S1104, determining a first TPMI table, where the first TPMI table includes codewords for first to eighth layers, and the TPMI corresponds to at least one of the codewords in the first TPMI table.

At step S1105, determining a second TPMI table and a number of layers, where the second TPMI table includes codewords for first to eighth layers, each of the codewords for a layer corresponds to an index, and the TPMI indicates the index within the number of layers.

At step S1106, determining a plurality of third TPMI tables and a number of layers, where each of the third TPMI tables corresponds to codewords for one layer, and the TPMI indicates codewords in the third TPMI tables corresponding to the number of layers.

It should be noted that there are three TPMI indication ways proposed in the implementations of the present disclosure: determining a first TPMI table, where the first TPMI table includes codewords for first to eighth layers, and the TPMI corresponds to at least one of the codewords in the first TPMI table; determining a second TPMI table and a number of layers, where the second TPMI table includes codewords for first to eighth layers, each of the codewords for a layer corresponds to an index, and the TPMI indicates the index within the number of layers; and determining a plurality of third TPMI tables and a number of layers, where each of the third TPMI tables corresponds to codewords for one layer, and the TPMI indicates codewords in the third TPMI tables corresponding to the number of layers, and at least one of three ways is adopted, i.e., any one of the three ways can be adopted, or any several of the three ways can be adopted, which is not limited.

The detailed description of step S1104 to step S1106 can be described with reference to the embodiments, and the embodiment of the present disclosure will not be repeated here.

In this embodiment, by sending the capability information of the terminal device to the network-side device, the network-side device can have the capability information of the terminal device. Since the capability information of the terminal device can indicate whether the terminal device supports non-coherent transmission, the network-side device can design the codebook in a targeted manner to ensure communication effectiveness.

FIG. 12 is a schematic structural diagram of an apparatus for generating an uplink 8-port codebook 120 according to an embodiment of the present disclosure. The apparatus for generating the uplink 8-port codebook 120 shown in FIG. 12 may include a transceiver module 1201 and a processing module 1202. The transceiver module 1201 is configured to realize sending and receiving functions.

The apparatus 120 for generating an uplink 8-port codebook may be a terminal device, an apparatus in the terminal device, or an apparatus that can be matched with the terminal device. Or, the apparatus 120 for generating an uplink 8-port codebook may be a network device, an apparatus in a network device, or an apparatus that can be used in matching with the network device.

The apparatus 120 for generating an uplink 8-port codebook, on the network device side, includes: a transceiver module 1201, configured to acquire a first codeword set; and a processing module 1202, configured to generate a second codeword set according to the first codeword set. The processing module 1202 is specifically configured to generate an uplink 8-port fully coherent transmission codeword set according to the second codeword set, and the processing module 1202 is further configured to generate an uplink 8-port codebook of the terminal device according to the uplink 8-port fully coherent transmission codeword set.

In some examples, the first codeword set includes any one of: an R15 downlink Type I codebook; a downsampling codebook generated by performing downsampling on sampling values selected by the R15 downlink Type I codebook; a subset of the R15 downlink Type I codebook; or a subset of the downsampling codebook.

In some examples, the processing module 1202 is further configured to: acquire probability distributions of optimal codewords for different numbers of layers; and generate the second codeword set from codewords in the first codeword set according to the probability distributions of the optimal codewords for different numbers of layers.

In some examples, the processing module 1202 is further configured to at least one of: select a codeword from the second codeword set according to a beam and add the selected codeword to the uplink 8-port fully coherent transmission codeword set; select a codeword from the second codeword set according to a co-phase coefficient and add the selected codeword to the uplink 8-port fully coherent transmission codeword set; select a codeword from the second codeword set according to the beam and the co-phase coefficient and add the selected codeword to the uplink 8-port fully coherent transmission codeword set; or in response to the terminal device including a plurality of panels, select a codeword from the second codeword set according to at least one of an inter-panel compensation factor, the beam or the co-phase coefficient, and add the selected codeword to the uplink 8-port fully coherent transmission codeword set.

In some examples, the processing module 1202 is further configured to: generate an uplink 8-port partially coherent transmission codeword set according to the uplink 8-port fully coherent transmission codeword set; acquire capability information of the terminal device; and generate the uplink 8-port codebook of the terminal device according to the capability information of the terminal device, the uplink 8-port fully coherent transmission codeword set and the uplink 8-port partially coherent transmission codeword set.

In some examples, the processing module 1202 is further configured to: in response to the terminal device supporting non-coherent transmission, use a port selection vector or a port selection matrix as an uplink 8-port non-coherent transmission codeword set.

In some examples, the processing module 1202 is further configured to: in response to the terminal device not supporting non-coherent transmission, take a union set of the uplink 8-port fully coherent transmission codeword set and the uplink 8-port partially coherent transmission codeword set as the uplink 8-port codebook; and in response to the terminal device supporting non-coherent transmission, take a union set of the uplink 8-port fully coherent transmission codeword set, the uplink 8-port partially coherent transmission codeword set, and the uplink 8-port non-coherent transmission codeword set as the uplink 8-port codebook.

In some examples, the processing module 1202 is further configured to: generate a transmit precoding matrix indicator (TPMI) according to the uplink 8-port codebook, and send the TPMI to the terminal device.

In some examples, TPMI indicates any one of: a union set of the uplink 8-port fully coherent transmission codeword set and an uplink 8-port partially coherent transmission codeword set; and a union set of the uplink 8-port fully coherent transmission codeword set, the uplink 8-port partially coherent transmission codeword set, and an uplink 8-port non-coherent transmission codeword set.

In some examples, the processing module 1202 is further configured to at least one of: determine a first TPMI table, where the first TPMI table includes codewords for first to eighth layers, and the TPMI corresponds to at least one of the codewords in the first TPMI table; determine a second TPMI table and a number of layers, where the second TPMI table includes codewords for first to eighth layers, each of the codewords for a layer corresponds to an index, and the TPMI indicates the index within the number of layers; or determine a plurality of third TPMI tables and a number of layers, where each of the third TPMI tables corresponds to codewords for one layer, and the TPMI indicates codewords in the third TPMI tables corresponding to the number of layers.

In this embodiment, by acquiring the first codeword set, generating the second codeword set according to the first codeword set, generating the uplink 8-port fully coherent transmission codeword set according to the second codeword set; and generating the uplink 8-port codebook of the terminal device according to the uplink 8-port fully coherent transmission codeword set, the number of codewords in the codebook can be effectively reduced, thereby reducing the overhead of transmit precoding matrix indicator according to the uplink 8-port codebook.

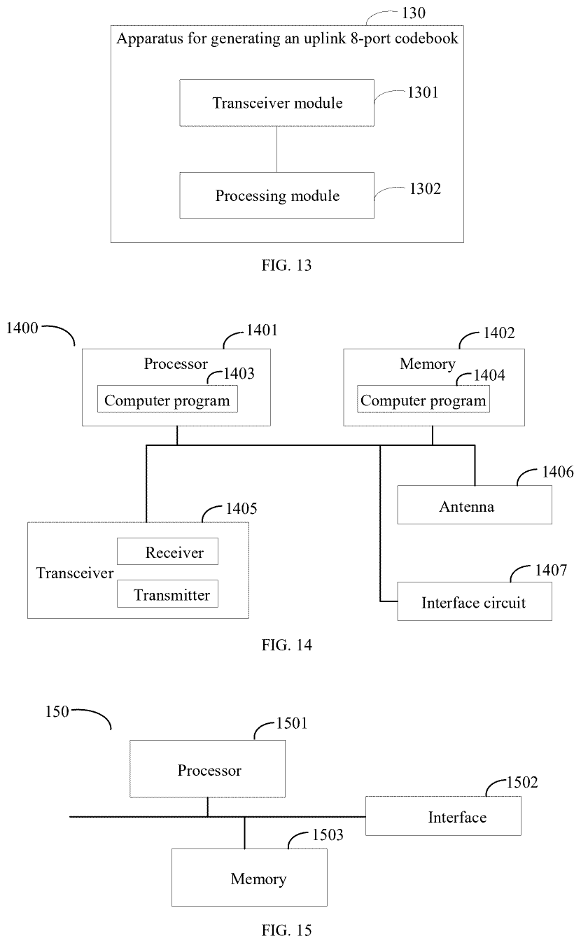

FIG. 13 is a schematic structural diagram of an apparatus for generating an uplink 8-port codebook 130 according to an embodiment of the present disclosure. The apparatus for generating the uplink 8-port codebook 130 shown in FIG. 13 may include a transceiver module 1301 and a processing module 1302. The transceiver module 1301 is configured to realize sending and receiving functions.

The apparatus 130 for generating an uplink 8-port codebook may be a terminal device, an apparatus in the terminal device, or an apparatus that can be matched with the terminal device. Or, the apparatus 130 for generating an uplink 8-port codebook may be a network device, an apparatus in a network device, or an apparatus that can be used in matching with the network device.

The apparatus 130 for generating an uplink 8-port codebook, on the terminal side, includes: a transceiver module 1301, configured to receive a transmit precoding matrix indicator (TPMI) sent by a network-side device, and determine an uplink 8-port codebook according to the TPMI.

In some examples, the transceiver module 1301 is further configured to: receive a rank indicator (RI) sent by the network-side device, and determine the uplink 8-port codebook according to the TPMI and the RI.

In some examples, the transceiver module 1301 is further configured to: send capability information of the terminal device to the network-side device.

In some examples, it further includes: a processing module 1302, configured to at least one of: determine a first TPMI table, where the first TPMI table includes codewords for first to eighth layers, and the TPMI corresponds to at least one of the codewords in the first TPMI table; determine a second TPMI table and a number of layers, where the second TPMI table includes codewords for first to eighth layers, each of the codewords for a layer corresponds to an index, and the TPMI indicates the index within the number of layers; and determine a plurality of third TPMI tables and a number of layers, where each of the third TPMI tables corresponds to codewords for one layer, and the TPMI indicates codewords in the third TPMI tables corresponding to the number of layers.

In this embodiment, by receiving the TPMI sent by the network-side device and determining the uplink 8-port codebook according to the TPMI, the uplink 8-port codebook can be determined according to the TPMI sent by the network-side device, so as to ensure that the terminal side can successfully determine the number of layers and the precoding matrix for uplink transmission according to the TPMI and the number of transmission layers, and then perform precoding and transmit data, thus ensuring the communication effect.

FIG. 14 is a schematic structural diagram of another communication apparatus according to an embodiment of the present disclosure. The communication apparatus 1400 may be a network device, a terminal device (such as the terminal device in the aforementioned method embodiments), a chip, a chip system, or a processor that supports network device to implement the methods, or a chip, a chip system, or a processor that supports the terminal device to implement the methods. The apparatus 1400 can be configured to realize the methods described in the method embodiments, for details, please refer to the description in the included method embodiments.

The communication apparatus 1400 may include one or more processors 1401. The processor 1401 may be a general purpose processor or a specialized processor, etc. Such as a baseband processor or a central processing unit. The baseband processor can be configured to process communication protocols as well as communication data, and the central processor can be configured to control a communication apparatus (e.g., a base station, a baseband chip, a terminal device, a terminal device chip, a DU or a CU, etc.), execute a computer program, and process data from a computer program.

In some examples, the communication apparatus 1400 may further include one or more memories 1402, on which a computer program 1404 may be stored, and a computer program 1403 may be stored in the processor 1401, and the processor 1401 executes the computer program 1404 and/or the computer program 1403, so that the communication apparatus 1400 can execute the methods described in the method embodiments. In some examples, data can also be stored in the memory 1402. The communication apparatus 1400 and the memory 1402 may be set separately or integrated together.

In some examples, the communication apparatus 1400 may further include a transceiver 1405 and an antenna 1406. The transceiver 1405 can be called a transceiver unit, a transceiver machine, a transceiver circuit, etc., and is configured to realize transceiver functions. The transceiver 1405 may include a receiver and a transmitter, and the receiver may be called a receiving machine or a receiving circuit, etc., and is configured to realize receiving functions. The transmitter can be called a transmitting machine or a transmitting circuit, etc., and is configured to realize transmitting functions.

In some examples, the communication apparatus 1400 may further include one or more interface circuits 1407. The interface circuit 1407 is configured to receive code instructions and transmit them to the processor 1401. The processor 1401 executes the code instructions to cause the communication apparatus 1400 to perform the methods described in the method embodiments.

The communication apparatus 1400 is a terminal device (such as the terminal device in the preceding method embodiments): the processor 1401 is configured to perform steps S202 to S204 in FIG. 2; steps S302 to S308 in FIG. 3; steps S502 to S505 in FIG. 5; steps S602 to S605 in FIG. 6; steps S702 to S707 in FIG. 7; steps S802 to S809 in FIG. 8; and steps S902 to S908 in FIG. 9. The transceiver 1405 is configured to perform step S201 in FIG. 2; step S301 in FIG. 3; step S501 in FIG. 5; step S601 in FIG. 6; step S701 in FIG. 7; step S801 in FIG. 8; and step S901 in FIG. 9.

The communication device 1400 is a network device: the processor 1401 is configured to execute steps S1104 to S1106 in FIG. 11. The transceiver 1405 is configured to perform step S1001 in FIG. 10; or to perform steps S1101 through S1103 in FIG. 11.

In an implementation, the processor 1401 may include a transceiver for implementing receiving and transmitting functions. For example, the transceiver can be a transceiver circuit, an interface, or an interface circuit. The transceiver circuits, interfaces or interface circuits for receiving and transmitting functions can be separated or integrated. The transceiver circuit, interface or interface circuit can be configured to read and write codes/data, or the transceiver circuit, interface or interface circuit can be configured to signal transmission or delivery.

In an implementation, the processor 1401 can store a computer program 1403, and the computer program 1403 runs on the processor 1401, which can make the communication apparatus 1400 execute the methods described in the method embodiments. The computer program 1403 may be solidified in the processor 1401, in which case, the processor 1401 may be implemented by hardware.

In an implementation, the communication apparatus 1400 may include a circuit, which may realize the function of transmitting or receiving or communicating in the method embodiments. The processor and transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver can also be manufactured by various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus in the description of embodiments may be a network device, or a terminal device (such as the first terminal device in the previous method embodiments), but the scope of the communication apparatus described in the present disclosure is not limited thereto, and the structure of the communication apparatus may not be limited by FIG. 14. The communication apparatus may be a stand-alone device or may be part of a larger device. For example, the communication apparatus may be: (1) a stand-alone integrated circuit IC, or chip, or system or subsystem of chips; (2) a collection of ICs having one or more, in some examples, the collection of ICs may also include storage components for storing data, computer programs; (3) an ASIC, such as a modem; (4) a module that can be embedded in other devices; (5) a receiver, a terminal device, an intelligent terminal device, a cellular phone, a wireless device, handset, mobile unit, a vehicle-mounted device, a network device, a cloud device, an artificial intelligence device, etc.; and/or (6) others, etc.

For the case that the communication apparatus can be a chip or a chip system, please refer to a structural schematic diagram of the chip shown in FIG. 15. The chip shown in FIG. 15 includes a processor 1501 and an interface 1502. The number of processors 1501 may be one or more and the number of interfaces 1502 may be more than one.

For the case where the chip is configured to realize the function of the terminal device (such as the first terminal device in the previous method embodiments) in the embodiments of the present disclosure.

The interface 1502 is configured to perform step S201 in FIG. 2; step S301 in FIG. 3; step S501 in FIG. 5; step S601 in FIG. 6; step S701 in FIG. 7; step S801 in FIG. 8; step S901 in FIG. 9; step S1001 in FIG. 10; step S1101 and step S1102 in FIG. 11; or step S1201 and step S1204 in FIG. 12.

For the case where the chip is configured to realize the function of the network device in the embodiments of the present disclosure.

The interface 1502 is configured to perform step S1301 of FIG. 13; perform step S1401 and step S1403 of FIG. 14; or step S1501 and step S1503 of FIG. 15.

In some examples, the chip further includes a memory 1503 for storing necessary computer programs and data.

Those skilled in the art can also understand that various illustrative logical blocks and steps listed in the embodiments of the present disclosure can be implemented by electronic hardware, computer software, or a combination of both. Whether such a function is realized in hardware or software depends on specific application and design requirements of an overall system. Those skilled in the art can use various methods to realize the described functions for each specific application, but this realization should not be understood as beyond the scope of protection of the embodiments of the present disclosure.

An embodiment of the present disclosure further provides a communication system, which includes a communication apparatus as a terminal device and a communication apparatus as a network device in the embodiment of FIG. 14, or the system includes a communication apparatus as a terminal device (such as the first terminal device in the previous method embodiments) and a communication apparatus as a network device in the embodiment of FIG. 15.

The present disclosure further provides a non-transitory computer-readable storage medium on which instructions are stored, which, when executed by a computer, realize the functions of any of the method embodiments.

The present disclosure further provides a computer program product which, when executed by a computer, realizes the functions of any of the method embodiments.

The present disclosure provides a chip system, which includes at least one processor and an interface, and is configured to realize the functions involved in the network device of any of the method embodiments, for example, determining or processing at least one of data and information related to the methods.

In a possible design, the chip system further includes a memory for storing necessary computer programs and data for a network device. The chip system can be composed of chips or include chips and other discrete devices.

The present disclosure provides a chip system, which includes at least one processor and an interface, and is configured to realize the functions involved in the terminal device of any of the method embodiments, for example, determining or processing at least one of data and information related to the methods.

In a possible design, the chip system further includes a memory for storing necessary computer programs and data for a terminal device. The chip system can be composed of chips or include chips and other discrete devices.

The present disclosure provides a computer program which, when run on a computer, causes the computer to perform the functions of any of the method embodiments.

In the embodiments, it can be realized in whole or in part by software, hardware, firmware or any combination thereof. When implemented using software, it may be implemented in whole or in part in the form of a computer program product. The computer program product includes one or more computer programs. When the computer program is loaded and executed on a computer, the flow or function according to the embodiments of the present disclosure is generated in whole or in part. The computer can be a general-purpose computer, a special-purpose computer, a computer network, or other programmable devices. The computer program can be stored in a computer-readable storage medium or transmitted from one computer-readable storage medium to another. For example, the computer program can be transmitted from a website, computer, server or data center to another website by wired (e.g., coaxial cable, optical fiber, digital subscriber line (DSL)) or wireless (e.g., infrared, wireless, microwave, etc.). The computer-readable storage medium may be any available medium that can be accessed by a computer or a data storage device such as a server, data center, etc. that contains one or more available media integrated. The available medium may be a magnetic medium (e.g., floppy disk, hard disk, magnetic tape), an optical medium (e.g., high-density digital video disc (DVD)), or a semiconductor medium (e.g., solid state disk (SSD)), etc.

A person of ordinary skill in the art may understand that “first”, “second”, and other various numerical numbers involved in the present disclosure are only described for the convenience of differentiation, and are not used to limit the scope of the embodiments of the present disclosure, nor do they indicate the order of precedence.

“At least one” in the present disclosure can further be described as one or more, and “a plurality” can be two, three, four or more, and the present disclosure is not limited. In the embodiment of the present disclosure, for a technical feature, the technical feature is distinguished by “first”, “second”, “third”, “A”, “B”, “C” and “D” etc. The technical features described in “first”, “second”, “third”, “A”, “B”, “C” and “D” are in no order of priority or size.

The correspondence shown in each table in the present disclosure can be configured or predefined. The values of the information in each table are only examples, and can be configured as other values, and the present disclosure is not limited. When configuring a correspondence between the information and each parameter, it is not necessary to configure all correspondences illustrated in each table. For example, in the table in the present disclosure, corresponding relationships shown by some rows may not be configured. For another example, appropriate deformation adjustments can be made based on the tables, such as splitting, merging, etc. The names of the parameters shown in the titles of the tables may also be other names understandable by the communication apparatus, and the values or expressions of the parameters may also be other values or expressions understandable by the communication apparatus. Each of the tables may also be implemented with other data structures, for example, an array, queue, container, stack, linear table, pointer, chain table, tree, graph, structure, class, heap, hash table, or hash table may be used.

Predefined in the present disclosure may be understood as defined, pre-definition, stored, pre-stored, pre-negotiated, pre-configured, cured, or pre-fired.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled people can use different methods to implement the described functions for each specific application, but such implementation should not be considered beyond the scope of the present disclosure.

It is clearly understood by those skilled in the field to which it belongs that, for the convenience and brevity of the description, the specific working processes of the described systems, apparatuses, and units can be referred to the corresponding processes in the foregoing embodiments of the method, and will not be repeated herein.

The foregoing are only specific embodiments of the present disclosure, but the scope of protection of the present disclosure is not limited thereto, and any person skilled in the art who is familiar with the technical field of the present disclosure can readily think of changes or substitutions within the technical scope of the present disclosure that should be covered within the scope of protection of the present disclosure. Therefore, the scope of protection of the present disclosure according to the scope of protection of the claims.

1. A method for generating an uplink 8-port codebook, performed by a network-side device and comprising:
acquiring a first codeword set;
generating a second codeword set according to the first codeword set;
generating an uplink 8-port fully coherent transmission codeword set according to the second codeword set; and
generating the uplink 8-port codebook of a terminal device according to the uplink 8-port fully coherent transmission codeword set.

2. The method according to claim 1, wherein the first codeword set comprises any one of:
an R15 downlink Type I codebook;
a downsampling codebook generated by performing downsampling on sampling values selected by the R15 downlink Type I codebook;
a subset of the R15 downlink Type I codebook; or
a subset of the downsampling codebook.

3. The method according to claim 1, wherein generating the second codeword set according to the first codeword set comprises:
acquiring probability distributions of optimal codewords for different numbers of layers; and
generating the second codeword set from codewords in the first codeword set according to the probability distributions of the optimal codewords for different numbers of layers.

4. The method according to claim 1, wherein generating the uplink 8-port fully coherent transmission codeword set according to the second codeword set comprises at least one of:
selecting a codeword from the second codeword set according to a beam and adding the selected codeword to the uplink 8-port fully coherent transmission codeword set;
selecting a codeword from the second codeword set according to a co-phase coefficient and adding the selected codeword to the uplink 8-port fully coherent transmission codeword set;
selecting a codeword from the second codeword set according to the beam and the co-phase coefficient and adding the selected codeword to the uplink 8-port fully coherent transmission codeword set; or
in response to the terminal device comprising a plurality of panels, selecting a codeword from the second codeword set according to at least one of an inter-panel compensation factor, the beam or the co-phase coefficient, and adding the selected codeword to the uplink 8-port fully coherent transmission codeword set.

5. The method according to claim 1, wherein generating the uplink 8-port codebook of a terminal device according to the uplink 8-port fully coherent transmission codeword set comprises:
generating an uplink 8-port partially coherent transmission codeword set according to the uplink 8-port fully coherent transmission codeword set;
acquiring capability information of the terminal device; and
generating the uplink 8-port codebook of the terminal device according to the capability information of the terminal device, the uplink 8-port fully coherent transmission codeword set and the uplink 8-port partially coherent transmission codeword set.

6. The method according to claim 5, further comprising:
in response to the terminal device supporting non-coherent transmission, using a port selection vector or a port selection matrix as an uplink 8-port non-coherent transmission codeword set.

7. The method according to claim 5, wherein generating the uplink 8-port codebook of the terminal device according to the capability information of the terminal device, the uplink 8-port fully coherent transmission codeword set and the uplink 8-port partially coherent transmission codeword set comprises:
in response to the terminal device not supporting non-coherent transmission, taking a union set of the uplink 8-port fully coherent transmission codeword set and the uplink 8-port partially coherent transmission codeword set as the uplink 8-port codebook; and
in response to the terminal device supporting non-coherent transmission, taking a union set of the uplink 8-port fully coherent transmission codeword set, the uplink 8-port partially coherent transmission codeword set, and the uplink 8-port non-coherent transmission codeword set as the uplink 8-port codebook.

8. The method according to claim 1, further comprising:
generating a transmit precoding matrix indicator (TPMI) according to the uplink 8-port codebook, and
sending the TPMI to the terminal device.

9. The method according to claim 8, wherein the TPMI indicates any one of:
a union set of the uplink 8-port fully coherent transmission codeword set and an uplink 8-port partially coherent transmission codeword set; and
a union set of the uplink 8-port fully coherent transmission codeword set, the uplink 8-port partially coherent transmission codeword set, and an uplink 8-port non-coherent transmission codeword set.

10. The method according to claim 8, further comprising at least one of:
determining a first TPMI table, wherein the first TPMI table comprises codewords for first to eighth layers, and the TPMI corresponds to at least one of the codewords in the first TPMI table;
determining a second TPMI table and a number of layers, wherein the second TPMI table comprises codewords for first to eighth layers, each of the codewords for a layer corresponds to an index, and the TPMI indicates the index corresponding to the codewords of the number of layers; or
determining a plurality of third TPMI tables and a number of layers, wherein each of the third TPMI tables corresponds to codewords for one layer, and the TPMI indicates codewords in the third TPMI tables corresponding to the number of layers.

11. A method for acquiring an uplink 8-port codebook, performed by a terminal device and comprising:
receiving a transmit precoding matrix indicator (TPMI) sent by a network-side device, and
determining the uplink 8-port codebook according to the TPMI.

12. The method according to claim 11, further comprising:
receiving a rank indicator (RI) sent by the network-side device, and
determining the uplink 8-port codebook according to the TPMI and the RI.

13. The method according to claim 11, further comprising:
sending capability information of the terminal device to the network-side device.

14. The method according to claim 11, further comprising at least one of:
determining a first TPMI table, wherein the first TPMI table comprises codewords for first to eighth layers, and the TPMI corresponds to at least one of the codewords in the first TPMI table;
determining a second TPMI table and a number of layers, wherein the second TPMI table comprises codewords for first to eighth layers, each of the codewords for a layer corresponds to an index, and the TPMI indicates the index corresponding to the codewords of the number of layers; or
determining a plurality of third TPMI tables and a number of layers, wherein each of the third TPMI tables corresponds to codewords for one layer, and the TPMI indicates codewords in the third TPMI tables corresponding to the number of layers.

15-16. (canceled)

17. A communication apparatus, comprising:
a processor; and
a memory storing a computer program, and
wherein the processor executes the computer program stored in the memory to cause the communication apparatus to:
acquire a first codeword set;
generate a second codeword set according to the first codeword set;
generate an uplink 8-port fully coherent transmission codeword set according to the second codeword set; and
generate an uplink 8-port codebook of a terminal device according to the uplink 8-port fully coherent transmission codeword set.

18. A communication apparatus comprising
a processor; and
a memory storing a computer program, and
wherein the processor executes the computer program stored in the memory to cause the communication apparatus to perform the method according to claim 11.

19. A communication device comprising:
an interface circuit
configured to receive code instructions and transmit them to the processor; and
a processor configured to run the code instructions to execute the method according to claim 1.

20. A communication device comprising:
an interface circuit;
configured to receive code instructions and transmit them to the processor; and
a processor configured to run the code instructions to execute the method according to claim 11.

21. A non-transitory computer-readable storage medium for storing instructions which, when the instructions are executed, cause the method according to claim 1 to be implemented.

22. A non-transitory computer-readable storage medium for storing instructions which, when the instructions are executed, cause the method according to claim 11 to be implemented.
